(19) United States
(12) Patent Application Publication
(10) Pub. No.: US 2025/0062429 A1
(43) Pub. Date: Feb. 20, 2025

(54) OPEN AIR BATTERY EMISSIONS DILUTION AND SAMPLING

(71) Applicant: HORIBA INSTRUMENTS INCORPORATED, Irvine, CA (US)

(72) Inventors: Montajir Rahman, Irvine, CA (US); Richard Stocker, Irvine, CA (US); Terry Sobczak, Irvine, CA (US); Joshua Israel, Irvine, CA (US)

(21) Appl. No.: 18/452,191

(22) Filed: Aug. 18, 2023

(51) Int. Cl. H01M 10/52; H01M 10/42; H01M 10/615; H01M 50/317

(52) U.S. Cl. CPC H01M 10/52; H01M 10/4285; H01M 10/615; H01M 50/317

(57) ABSTRACT

An open air battery emissions dilution and sampling system includes a sample accumulator that defines a funneled cavity having an open end exposed to ambient dilution air and that captures and dilutes with the ambient dilution air emissions from a battery, at least partially disposed within the funneled cavity and experiencing thermal runaway, to form diluted exhaust.

### TECHNICAL FIELD

This disclosure relates to test equipment for batteries.

### BACKGROUND

Appropriate sampling can be important for measuring emissions from a battery (cell, module, pack, etc.).

A gas chromatograph-mass spectrometer can detect and identify trace amounts of volatile organic compounds and other gases emitted by batteries.

Differential scanning calorimetry instruments can measure the heat flow of a battery during its operation, allowing for the identification of exothermic reactions that might lead to thermal runaway, as well as the energy released during thermal runaway stages.

Fourier-transform infrared spectrometers can identify specific chemical bonds and functional groups present in emissions from batteries.

Real-time monitoring is a feature of some battery emissions testing equipment. Sensors can provide continuous data on temperature, gas concentrations, and other parameters during battery operation.

Some battery emissions testing equipment incorporate enclosures that can prevent energy, emissions, and debris from escaping during thermal runaway.

Equipment and controls for initiating thermal runaway in a battery can include nail penetration, controlled heating pads, and electrical connections for overcharge/overvoltage initiation.

### SUMMARY

An open air battery emissions dilution and sampling system includes a sample accumulator defining a funneled cavity having an open end exposed to ambient dilution air and that captures and dilutes, with the ambient dilution air, emissions from a battery, at least partially disposed within the funneled cavity and experiencing thermal runaway, to form diluted exhaust. The system also includes a positive displacement pump or blower, and tubing, defining at least one port, attached between an outlet of the sample accumulator and the positive displacement pump or blower such that operation of the positive displacement pump or blower creates suction within the funneled cavity to draw the ambient dilution air into the funneled cavity and move the diluted exhaust through the tubing.

A method includes, prior to a battery experiencing thermal runaway and that is at least partially disposed within a funneled cavity of a sample accumulator having an open end exposed to ambient dilution air and that captures and dilutes, with the ambient dilution air, emissions from the battery while the battery is experiencing thermal runaway to form diluted exhaust, activating a positive displacement pump or blower to create suction within the funneled cavity to draw the ambient dilution air into the funneled cavity and move the ambient dilution air through tubing that defines at least one port and is attached between the sample accumulator and positive displacement pump or blower, and measuring a sample of the ambient dilution air from at least one sample probe disposed within the at least one port. The method also includes while the battery is experiencing thermal runaway such that the emissions and ambient dilution air form the diluted exhaust, measuring a sample of the diluted exhaust from the at least one sample probe.

### BRIEF DESCRIPTION OF THE DRAWINGS

FIG. 1 is a schematic diagram of an open air battery emissions test arrangement.

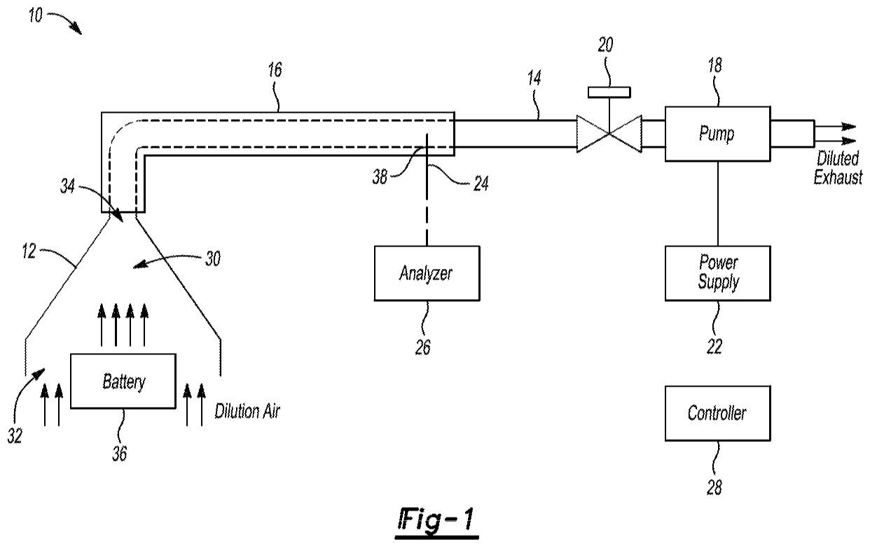

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated or described may be combined to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Lithium-ion batteries typically include a positive electrode (cathode), a negative electrode (anode), an electrolyte solution, and a separator. The electrodes can be made of materials that intercalate (absorb) and de-intercalate lithium ions during charge and discharge cycles. The electrolyte facilitates movement of lithium ions between the electrodes, while the separator prevents electron movement through the electrolyte. This forces electrons to go through an external circuit, generating electric current.

During normal operation, lithium ions move between the cathode and anode through the electrolyte, generating heat energy. This energy is directly proportional to the flow of current. When the battery experiences an internal short, a large amount of current, and therefore heat generation, is observed. When the battery experiences an event that causes it to heat up quickly (e.g., as during thermal runaway), such as through external puncture or internal short circuits, several chemical reactions can be triggered that lead to the production of emissions.

The electrolyte in a lithium-ion battery is typically a lithium salt dissolved in a solvent. At high temperatures, the electrolyte can decompose, releasing gases such as carbon dioxide, carbon monoxide, and volatile organic compounds. This breakdown occurs due to the thermal degradation of the solvent and the lithium salt. In other variations, the electrolyte can be made of a solid material. This material can be a polymer, oxide, sulfide, halide, or other composition, and the nature and constitution of corresponding emissions can vary significantly.

The cathode material in lithium-ion batteries often contains metal oxides, such as lithium cobalt oxide or lithium iron phosphate. Cathode materials can also contain more complex compounds such as nickel manganese cobalt and nickel cobalt aluminum. At elevated temperatures, these metal oxides can undergo chemical reactions that release oxygen. If oxygen reacts with other materials within the battery, it can contribute to the generation of gases like carbon monoxide and carbon dioxide. The release of oxygen also allows for the continuous burning of lithium-ion batteries without external oxygen present.

The anode is typically made of graphite or other carbon-based materials. Other anode materials include silicon, lithium titanate oxide, and pure lithium metal. At high temperatures, these materials can react with the electrolyte or other components, potentially releasing gases. Additionally, in some cases, the anode may undergo a process in which the anode material reacts exothermically with lithium compounds, further raising the temperature.

Within the battery, there may be organic components that can oxidize or decompose at elevated temperatures. These reactions can release volatile organic compounds and other byproducts, contributing to the emissions produced during thermal runaway.

As the battery's internal temperature increases, the casing may become compromised, exposing reactive materials to the environment. This can lead to further exothermic reactions and gas generation.

The exact emissions generated during a thermal runaway event can vary based on a number of factors such as the battery chemistry, materials used, and specific conditions of the runaway. Batteries may thus be tested to evaluate the nature of their emissions and their tendency to produce the same.

Certain test arrangements are contemplated herein. In some cases however, an enclosed chamber around the battery is not possible. An ‘open air’ setup may be required. This setup would still need to capture the emissions effectively, and mix the emissions with diluted air to bring the emissions into the correct range for the measurement equipment.

A ‘funnel’ allows for the capture of the gaseous and solid particle emissions. A range of sizes can be applied to get the right mix of emissions and dilution for each test specimen. A dilution probe allows for quantification of the dilution gas to include in calculations. The funnel may be combined with extraction flow to capture the emissions coming from the battery and channel them through the emissions setup.

The emissions from a battery may be captured and analyzed without needing a full enclosure. The contemplated arrangements may also include the ability to incorporate dilution air from around the battery which can be used to bring the emissions into the correct concentration range for the measurement equipment.

The size and shape of the funnel may vary. The air around the battery may be normal air, or it may be specific dilution air where the constituents are controlled. The dilution probe may also vary for specific applications. The shape and specification of the funnel can encourage air mixing with the emissions for consistent dilution.

With regard to claim 1, a battery emissions test arrangement 10 includes a sample accumulator 12, tubing 14, a heater 16, a positive displacement pump 18, a valve 20, a power supply 22, at least one sample probe 24, at least one analyzer 26, and a controller 28.

The sample accumulator 12 defines a funnel shaped cavity 30 with an open end 32 exposed to ambient air and an outlet 34 attached with the tubing 14. The funnel shaped cavity 30, which in this example is oriented vertically such that the open end 32 is on bottom and the outlet 34 is on top, is of sufficient size to permit a battery 36 to be at least partially disposed therein. As gas from the battery is emitted, it will thus rise and be captured and mixed by the sample accumulator along with ambient air to form diluted exhaust gas.

The tubing 14 is connected between the positive displacement pump 18 and outlet 34 such that the diluted exhaust gas captured by the sample accumulator 12 and funneled into the tubing 14 via the outlet 34 travels there along toward the positive displacement pump 18. Ninety degree bends of the tubing 14 should be avoided if possible. Indeed, it may be helpful if curves of the tubing have a radius at least four times the diameter of the tubing 14. A Reynolds number associated with the tubing 14, in some examples, should be greater than 1700.

In this example, the tubing 14 is surrounded by the heater 16 (e.g., a heated jacket), which heats the diluted exhaust gas to suppress condensation thereof. The heater 16 can take different forms depending on test requirements and tubing arrangements, or may be absent (as with other components) if not needed. The tubing 14 defines at least one port 38 into which the sample probe 24 is mounted.

The sample probe 24 is connected with the analyzer 26 to deliver samples of diluted exhaust thereto for analysis.

The power supply 22, in this example, is a variable AC power supply arranged to supply varying AC power to the pump 18 so the pump 18 can draw fluids through the tubing 14 at varying rates as test schedules require.

The valve 20 can also be used to throttle the flow of fluids through the tubing 14 and can assume several positions to effect the same.

The controller 28 is in communication with/exerts control over the positive displacement pump 18, valve 20, power supply 22, and analyzer 26. That is, the controller 28 may issue commands to one or more of the same to, for example, increase the flow rate through the tubing 14, analyze samples from the tubing 14, etc.

Thermal runaway of the battery 36 can be initiated, for example, by applying heat, piercing, or overcharging. The controller 28 may initiate operation of the positive displacement pump 18 and analyzer 26 prior to initiating thermal runaway to obtain baseline emissions measurements of the ambient air. These measurements may continue once thermal runaway has begun and the battery 36 begins to release emissions.

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. A blower, for example, may be used instead of the positive displacement pump 18. Other components and variations are, of course, contemplated.

The words used in the specification are words of description rather than limitation, and it is understood that various changes may be made without departing from the spirit and scope of these disclosed materials. And the terms “controller” and “controllers” can be used interchangeably herein as the functionality of a controller can be distributed across several controllers/modules, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An open air battery emissions dilution and sampling system comprising:
a sample accumulator defining a funneled cavity having an open end exposed to ambient dilution air and configured to capture and dilute, with the ambient dilution air, emissions from a battery, at least partially disposed within the funneled cavity and experiencing thermal runaway, to form diluted exhaust;
a positive displacement pump or blower; and
tubing, defining at least one port, attached between an outlet of the sample accumulator and the positive displacement pump or blower such that operation of the positive displacement pump or blower creates suction within the funneled cavity to draw the ambient dilution air into the funneled cavity and move the diluted exhaust through the tubing.

2. The system of claim 1 further comprising a heater surrounding the tubing and the at least one port, and configured to heat the diluted exhaust to suppress condensation of the diluted exhaust.

3. The system of claim 1 further comprising at least one sample probe inserted into the at least one port.

4. The system of claim 3 further comprising at least one analyzer connected with the at least one sample probe.

5. The system of claim 4, wherein the at least one analyzer is configured to measure samples from the at least one sample probe before and after the battery experiences thermal runaway.

6. The system of claim 1 further comprising a controller programmed to initiate operation of the positive displacement pump or blower prior to the battery experiencing thermal runaway.

7. The system of claim 1 further comprising a valve arranged with the tubing and configured to throttle a flow rate of the diluted exhaust through the tubing.

8. The system of claim 1, wherein the positive displacement pump or blower is a variable positive displacement pump or variable blower.

9. A method comprising:
prior to a battery experiencing thermal runaway and that is at least partially disposed within a funneled cavity of a sample accumulator having an open end exposed to ambient dilution air and configured to capture and dilute, with the ambient dilution air, emissions from the battery while the battery is experiencing thermal runaway to form diluted exhaust, (i) activating a positive displacement pump or blower to create suction within the funneled cavity to draw the ambient dilution air into the funneled cavity and move the ambient dilution air through tubing that defines at least one port and is attached between the sample accumulator and positive displacement pump or blower and (ii) measuring a sample of the ambient dilution air from at least one sample probe disposed within the at least one port; and
while the battery is experiencing thermal runaway such that the emissions and ambient dilution air form the diluted exhaust, measuring a sample of the diluted exhaust.

10. The method of claim 9 further comprising heating the tubing.
